(19) United States
(12) Patent Application Publication
(10) Pub. No.: US 2017/0228678 A1
(43) Pub. Date: Aug. 10, 2017

(54) CONTROL APPARATUS, CONTROL SYSTEM, COMPUTER-READABLE RECORDING MEDIUM, AND CONTROL METHOD

(71) Applicant: FUJI ELECTRIC CO., LTD., Kanagawa (JP)

(72) Inventors: Yoshio TANGE, Tokyo (JP); Satoshi KIRYU, Tokyo (JP)

(21) Appl. No.: 15/412,196

(22) Filed: Jan. 23, 2017

(30) Foreign Application Priority Data
Feb. 10, 2016 (JP) 2016-023938

(51) Int. Cl. G06Q 10/06

(52) U.S. Cl. CPC G06Q 10/06315

(57) ABSTRACT

A control apparatus controls a demand-supply system, which includes resource supplying facilities configured to supply resources and at least one resource demander facility configured to demand the resources supplied from the plurality of resource supplying facilities. The control apparatus includes a minimum cost calculating unit configured to calculate, upon a total demand of the resources demanded in the at least one resource demander facility being input, a minimum cost necessary for the resource supplying facilities to supply the resources of the total demand based on the total demand and a cost necessary for the resource supplying facilities to supply the resources; and a supply quantity calculating unit configured to calculate optimum supply quantities of the respective resource supplying facilities based on the minimum cost, the total demand, and a supply quantity of the resources to be supplied from at least one resource supplying facility of the resource supplying facilities.

### CROSS-REFERENCE TO RELATED APPLICATION

The present application is based on and claims the benefit of priority of Japanese Priority Application No. 2016-023938 filed on Feb. 10, 2016, the entire contents of which are hereby incorporated by reference.

### BACKGROUND OF THE INVENTION

1. Field of the Invention

The present invention relates to a control apparatus, a control system, a computer-readable recording medium, and a control method.

2. Description of the Related Art

A technique is known in the related art which determines, in accordance with a total demand of a facility that demands resources, allocation of production/supply quantities of the resources such as steam or cold heat that a plurality of facilities produce and supply such that the cost (for example, gas, heavy oil, electric power or the like) is optimum.

For example, Patent Document 1 discloses a technique that calculates, based on a characteristic model that models characteristics of each device of a BTG plant, various process quantities, and the like, an optimum solution of a steam allocation quantity of each turbine and a steam production quantity of a boiler such that the energy cost is minimum. In such a technique, for example, an optimum solution for allocation of production/supply quantities is calculated by solving an optimization problem such as a linear programing problem and a quadratic programing problem.

However, because a matrix calculation depending on the number of variables and constraint conditions or a repeated calculation for converging a solution is required to solve the optimization problem, implementation is difficult for a device, of which hardware resources such as a memory and a Central Processing Unit (CPU) are limited, in some cases.

### PATENT DOCUMENT

[Patent Document 1] Japanese Laid-open Patent Publication No. 2007-255198

### SUMMARY OF THE INVENTION

One embodiment of the present invention is made in light of the above problems and has an object to determine optimum allocation in various devices.

According to an embodiment, there is provided a control apparatus for controlling a demand-supply system. The demand-supply system includes a plurality of resource supplying facilities configured to supply resources and at least one resource demander facility configured to demand the resources supplied from the plurality of resource supplying facilities. The control apparatus includes a minimum cost calculating unit configured to calculate, upon a total demand of the resources demanded in the at least one resource demander facility being input, a minimum cost necessary for the plurality of resource supplying facilities to supply the resources of the total demand based on the total demand and a cost necessary for the plurality of resource supplying facilities to supply the resources; and a supply quantity calculating unit configured to calculate optimum supply quantities of the respective resource supplying facilities based on the minimum cost, calculated by the minimum cost calculating unit, the total demand, and a supply quantity of the resources to be supplied from at least one resource supplying facility of the plurality of resource supplying facilities.

### BRIEF DESCRIPTION OF THE DRAWINGS

Other objects, features and advantages of the present invention will become more apparent from the following detailed description when read in conjunction with the accompanying drawings.

FIG. 1 is a block diagram illustrating an example of a configuration of a control system according to a first embodiment;

FIG. 2 is a block diagram illustrating an example of a hardware configuration of a control apparatus according to the first embodiment;

FIG. 3 is a block diagram illustrating an example of a functional configuration of the control apparatus according to the first embodiment;

FIG. 4 is a diagram illustrating a demand-supply system model;

FIGS. 5A to 5C are graphs illustrating examples of capacities of respective resource supplying facilities;

FIG. 6 is a diagram illustrating an example of a first relational expression according to the first embodiment;

FIG. 7 is a diagram illustrating an example of a second relational expression according to the first embodiment;

FIG. 8 is a flowchart illustrating an example of processing of determining optimum allocation according to the first embodiment group;

FIG. 9 is a graph illustrating an example of calculating a minimum total cost C₀;

FIG. 10 is a graph illustrating an example of calculating an optimum supply quantity T₁;

FIG. 11 is a graph illustrating an example of calculating an optimum supply quantity T₂;

FIG. 12 is a graph illustrating an example of calculating an optimum supply quantity T₃;

FIG. 13 is a block diagram illustrating an example of a configuration of a control system according to a second embodiment;

FIG. 14 is a block diagram illustrating an example of a functional configuration of a control apparatus according to the second embodiment;

FIG. 15 is a diagram illustrating another example of a demand-supply system model;

FIG. 16 is a diagram illustrating another example of capacities of respective resource supplying facilities;

FIG. 17 is a diagram illustrating an example of a first relational expression according to the second embodiment;

FIG. 18 is a diagram illustrating an example of a second relational expression group according to the second embodiment;

FIG. 19 is a flowchart illustrating an example of processing of determining optimum allocation according to the second embodiment;

FIG. 20 is a diagram illustrating another example of calculating a minimum total cost C₀;

FIG. 21 is a diagram illustrating another example of calculating an optimum supply quantity T₁; and

FIG. 22 is a diagram illustrating another example of calculating an optimum supply quantity T₂.

### DETAILED DESCRIPTION OF THE PREFERRED EMBODIMENTS

In the following, embodiments of the present invention will be described in detail with reference to the accompanying drawings.

### First Embodiment

<System Configuration>

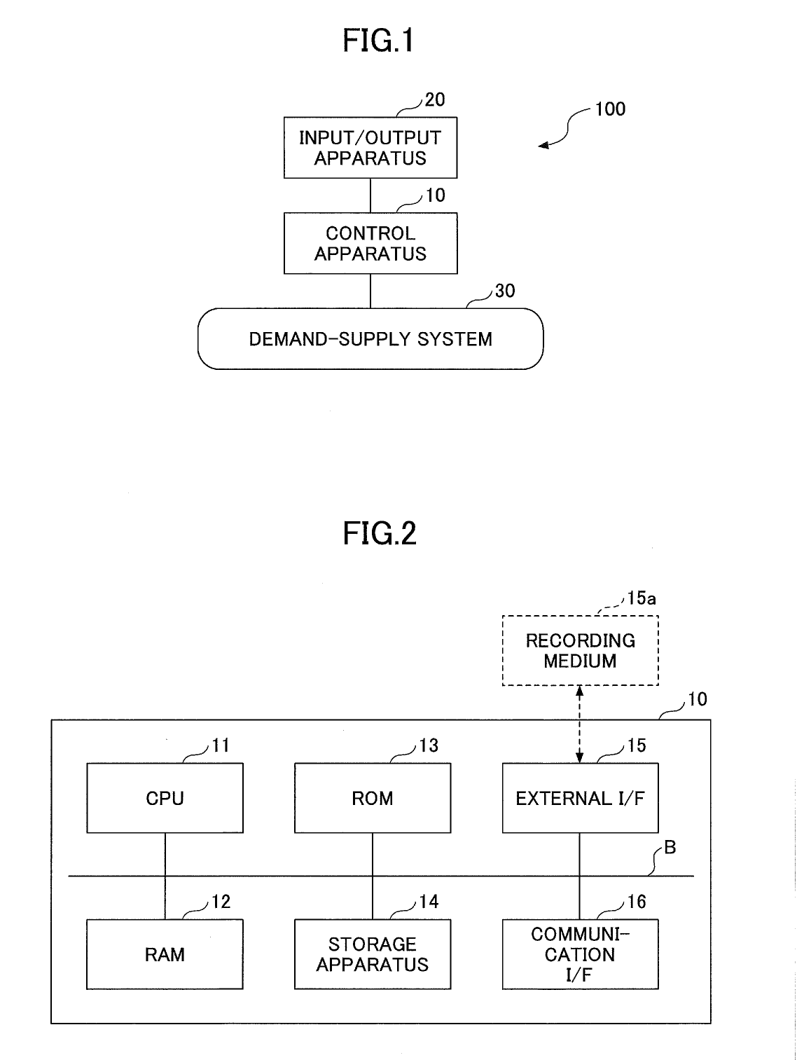

First, a system configuration of a control system 100 according to a first embodiment will be described with reference to FIG. 1. FIG. 1 is a block diagram illustrating an example of the system configuration of the control system 100 according to the first embodiment.

The control system 100 illustrated in FIG. 1 includes a control apparatus 10 and an input/output apparatus 20, and controls a demand-supply system 30. Here, the demand-supply system 30 is a system that includes at least one resource supplying facility, which produces and supplies resources, and at least one resource demander facility, which demands the resources that are supplied from the resource supplying facility. For example, the demand-supply system 30 may be an electric power system that includes at least one steam generating facility, which produces and supplies “steam” as resources, and at least one resource demander facility, which demands the “steam” and produces electric power or the like.

For example, the control apparatus 10 may be a Programmable Logic Controller (PLC), an embedded device, or the like. The control apparatus 10 determines, in accordance with a total demand (total quantity demanded) that the resource demander facility requests, optimum allocation of respective resource supplying facilities, which is optimum allocation of supply quantities of resources that the respective resource supplying facilities supply. Further, the control apparatus 10 controls, based on the determined allocation, quantities of resources to be produced and supplied in the respective resource supplying facilities included in the demand-supply system 30.

When allocation of supply quantities is optimum allocation, a total of supply quantities of resources, which respective resource supplying facilities supply, satisfies a total demand, and a total of costs (such as gas, heavy oil, and electric power, for example,) necessary for the respective resource supplying facilities to generate the resources is minimum.

For example, the input/output apparatus 20 may be a programmable display device or the like. The input/output apparatus 20 is used to input, to the control apparatus 10, various kinds of information such as a total demand of resources that a resource demander facility included in the demand-supply system 30 demands, for example. Here, the input/output apparatus 20 may be directly connected to the control apparatus 10 or connected to the control apparatus 10 via a network or the like. In the following, a total demand of resources that a resource demander facility requests is referred to as the “requested total quantity” (requested total quantity demanded).

As described above, the control system 100 according to the first embodiment includes the control apparatus 10, of which hardware resources are comparatively limited in comparison with a Personal Computer (PC) or the like, and the input/output apparatus 20, which is used to input various kinds of information to the control apparatus 10. Then, the control system 100 according to the first embodiment causes the control apparatus 10 to determine optimum allocation of supply quantities of resources of respective resource supplying facilities included in the demand-supply system 30 and to perform control such that the respective resource supplying facilities are optimally operated.

<Hardware Configuration>

Next, a hardware configuration of the control apparatus 10 according to the first embodiment will be described with reference to FIG. 2. FIG. 2 is a block diagram illustrating an example of the hardware configuration of the control apparatus 10 according to the first embodiment.

The control apparatus 10 illustrated in FIG. 2 includes a Central Processing Unit (CPU) 11, a Random Access Memory (RAM) 12, a Read Only Memory (ROM) 13, a storage apparatus 14, an external I/F 15, and a communication I/F 16. These hardware elements are coupled with each other via a bus B in a communicative manner.

The CPU 11 reads, from the ROM 13 or the storage apparatus 14, at least one program and/or data into the RAM 12 to execute processing. The CPU 11 is an arithmetic device that actualizes overall control and functions of the control apparatus 10 by executing the processing.

The RAM 12 is a volatile semiconductor memory that temporarily holds (stores) programs and/or data. The ROM 13 stores data such as a network setup and an Operating System (OS) setup of the control apparatus 10.

The storage apparatus 14 is a non-volatile storage device that stores various programs and/or data. The programs and/or data stored in the storage apparatus may include one or more programs for realizing the embodiment, an operating system (OS), which is basic software for controlling the entire control apparatus 10, one or more programs for providing various functions in the OS, and so on.

The external I/F 15 is an interface with an external apparatus. The external apparatus may be a recording medium 15a or the like. With this configuration, the control apparatus 10 can read information (data) from the recording medium 15a and/or write information (data) to the recording medium 15a through the external I/F 15. The recording medium 15a may be a flexible disk, a CD, a DVD, an SD memory card, a USB memory, or the like.

The communication I/F 16 is an interface for coupling the control apparatus 10 to a network. With this configuration, the control apparatus 10 can perform data communication via the communication I/F 16. The control apparatus 10 according to the first embodiment has the above described hardware configuration to actualize various kinds of processing, which will be described below.

<Functional Configuration>

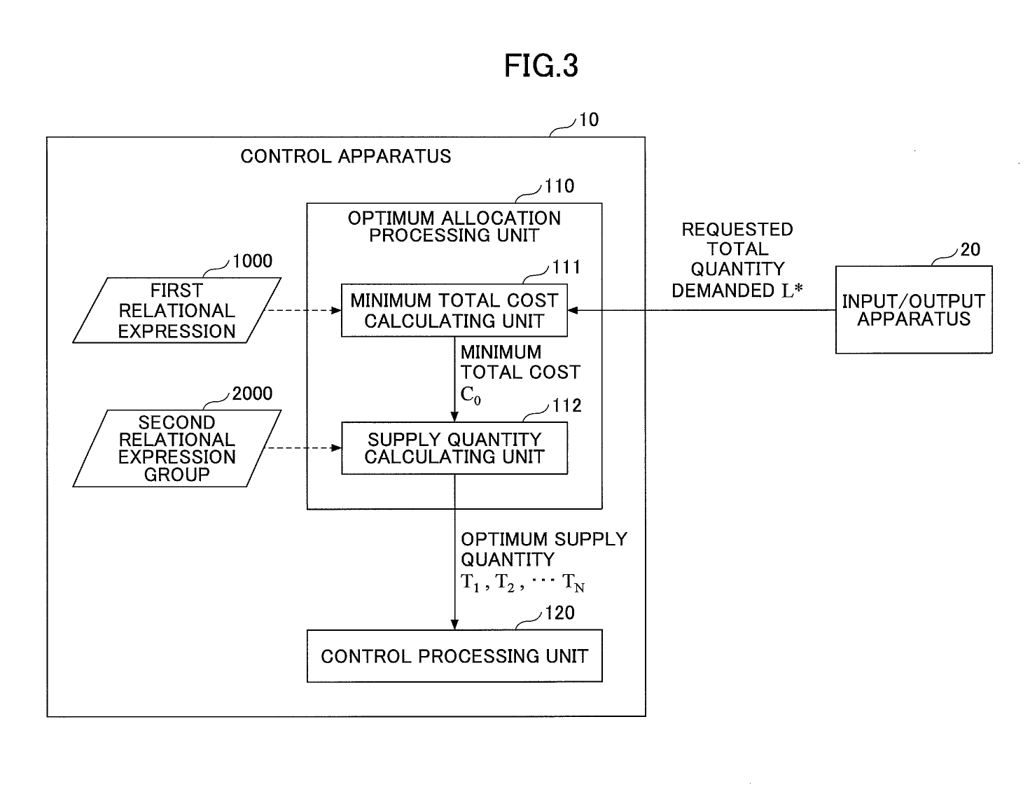

Next, a functional configuration of the control apparatus 10 according to the first embodiment will be described with reference to FIG. 3. FIG. 3 is a block diagram illustrating an example of the functional configuration of the control apparatus 10 according to the first embodiment.

The control apparatus 10 illustrated in FIG. 3 includes an optimum allocation processing unit 110 and a control processing unit 120. These functional units (elements) are actualized by processing that at least one program, installed in the control apparatus 10, causes the CPU 11 to execute.

Further, the control apparatus 10 includes a first relational expression 1000 and a second relational expression group 2000. The first relational expression 1000 and the second relational expression group 2000 are stored in the storage apparatus 14, for example.

The optimum allocation processing unit 110 executes determination processing of optimum allocation to determine optimum allocation of each resource supplying facility included in the demand-supply system 30. Here, the optimum allocation processing unit 110 includes a minimum total cost calculating unit 111 and a supply quantity calculating unit 112.

The minimum total cost calculating unit 111 obtains a requested total demand (requested total quantity demanded) L* input in the input/output apparatus 20. Then, using the first relational expression 1000, the minimum total cost calculating unit 111 calculates a minimum value of a total cost (minimum total cost C₀) necessary for the resource supplying facilities to supply, to the resource demander facility, supply quantities, which satisfies the requested total demand L*.

Upon the minimum total cost C₀ being calculated by the minimum total cost calculating unit 111, the supply quantity calculating unit 112 calculates optimum supply quantities for the respective resource supplying facilities included in the demand-supply system 30 by using the second relational expression group 2000.

That is, the supply quantity calculating unit 112 calculates the supply quantities of the respective resource supplying facilities such that a total of the supply quantities of the respective resource supplying facilities included in the demand-supply system 30 is the requested total demand L* and a total cost of the resource supplying facilities is the minimum total cost C₀. For example, in a case where resource supplying facilities 1 to N are included in the demand-supply system 30, the supply quantity calculating unit 112 calculates supply quantities T₁ to T_{N} of the respective resource supplying facilities 1 to N such that a total of the supply quantities of the respective resource supplying facilities 1 to N is the requested total demand L* and a total cost of the resource supplying facilities 1 to N is the minimum total cost C₀. The supply quantities T₁ to T_{N} calculated as described above are optimum supply quantities of the respective resource supplying facilities.

The control processing unit 120 controls the respective resource supplying facilities based on the optimum supply quantities of the respective resource supplying facilities calculated by the optimum allocation processing unit 110. That is, for example, based on the supply quantities T₁ to T_{N} of the respective resource supplying facilities calculated by the optimum allocation processing unit 110, the control processing unit 120 controls the respective resource supplying facilities such that the supply quantities to be supplied from the respective resource supplying facilities are the calculated supply quantities T₁ to T_{N}.

It should be noted that in a case where the control apparatus 10 is constituted with a plurality of devices or apparatuses, for example, the optimum allocation processing unit 110 and the control processing unit 120 may be realized by different devices or apparatuses.

The first relational expression 1000 is an expression that describes a relationship between variable L, which represents a total demand (total quantity demanded) of resources that the resource demander facility included in the demand-supply system demands, and variable C, which represents a total cost of the resource supplying facilities included in the demand-supply system 30. That is, the first relational expression 1000 is a Boolean-Valued function, which can take true or false as a function value, and is indicated as follows.

Φ₁(C, L)=true or false <Expression 1>

C: TOTAL COST

L: TOTAL QUANTITY DEMANDED

The second relational expression group 2000 is a set (group) of expressions that describe relationships between variable C, which represents the total cost, variable L, which represents the total demand, and variables S₁ to S_{N}, which represent supply quantities of the respective resource supplying facilities. In other words, the expressions of the second relational expression group 2000 represent, for the respective resource supplying facilities, relationships between the total cost, the total demand, and the supply quantities (supply capacities) of the resource supplying facilities. That is, similar to the first relational expression 1000, the second relational expression group 2000 is a set (group) of Boolean-Valued functions, which can take true or false as a function value, and is indicated as follows.

$${Φ}_{2 , 1} ( C , L , {S}_{1} ) = true or false \\ {Φ}_{2 , 2} ( C , L , {S}_{1} , {S}_{2} ) = true or false \\ ⋮ \\ {Φ}_{2 , N} ( C , L , {S}_{1} , {S}_{2} , … , {S}_{N} ) = true or false \\ C \text{:} TOTAL COST \\ L \text{:} TOTAL QUANTITY DEMAND \\ {S}_{1} \text{:} SUPPLY QUANTITY \\ OF RESOURCE SUPPLYING \\ FACILITY 1 \\ {S}_{2} \text{:} SUPPLY QUANTITY \\ OF RESOURCE SUPPLYING \\ FACILITY 2 \\ ⋮ \\ {S}_{N} \text{:} SUPPLY QUANTITY OF RESOURCE SUPPLYING \\ FACILITY N \qquad < Expression ( s ) 2 >$$

For example, the first relational expression 1000 and the second relational expression group 2000 are previously created in a computer such as a PC, which is different from the control apparatus 10. The first relational expression 1000 and the second relational expression group 2000 are previously created by a method disclosed in International Publication Pamphlet No. WO 2014/129470 based on a demand-supply system model, which indicates the demand-supply system 30, and facility capacities of respective resource supplying facilities. Then, the first relational expression 1000 and the second relational expression group 2000 stored in the recording medium 15a are stored in the storage apparatus 14 of the control apparatus 10 via the external I/F 15, for example. It should be noted that the first relational expression 1000 is an example of first information, and the second relational expression group 2000 is an example of a plurality of sets of second information.

However, the control apparatus 10 is not limited to this. For example, the control apparatus 10 may download the first relational expression 1000 and the second relational expression group 2000 from a computer connected to a network via the communication I/F 16 and store the first relational expression 1000 and the second relational expression group 2000 in the storage apparatus 14. Further, in a case where a CPU or the like having a sufficient processing capacity is mounted on the control apparatus 10, for example, the control apparatus 10 may create the first relational expression 1000 and the second relational expression group 2000.

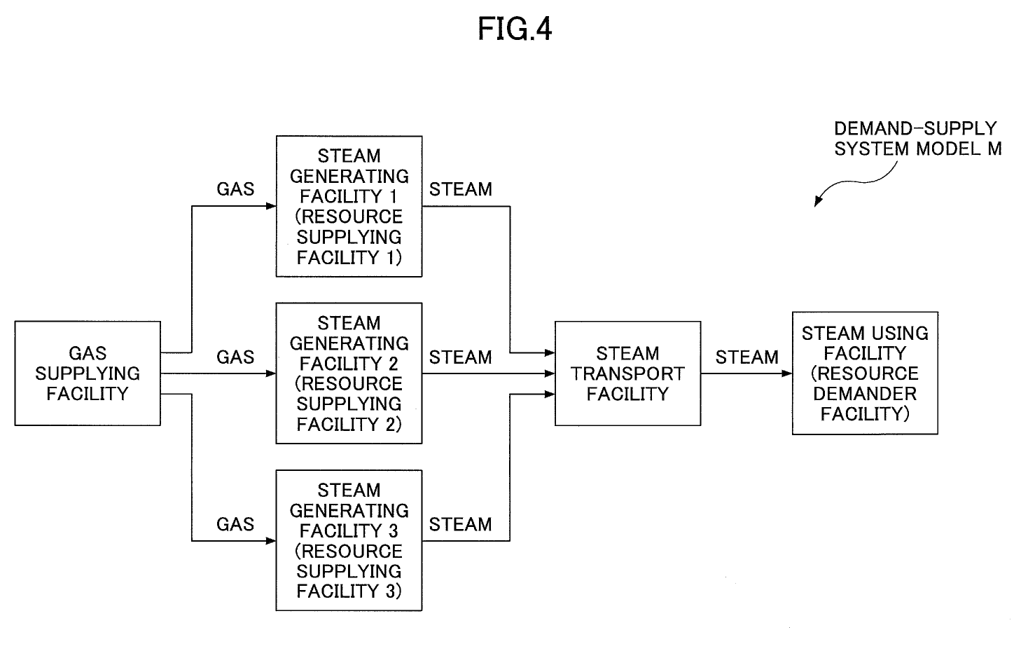

Here, a specific example of the first relational expression 1000 and the second relational expression group 2000 created in the computer such as the PC will be described, for example. First, FIG. 4 illustrates a demand-supply system model M, which indicates the demand-supply system 30. That is, the demand-supply system model M illustrated in FIG. 4 causes each of steam generating facilities 1 to 3 to use gas supplied from a gas supplying facility as a fuel and to generate steam. Then, the demand-supply system model M causes a steam transport facility to supply the steam to a steam using facility, in which the steam is demanded.

Here, each of the steam generating facilities 1 to 3 is a “resource supplying facility”, and the steam using facility is a “resource demander facility”. Further, the gas consumed, in each of the steam generating facilities 1 to 3, as the fuel is a “cost”, and the steam, supplied from each of the steam generating facilities 1 to 3, is a “resource”. It should be noted that although one resource demander facility is included in the demand-supply system model M illustrated in FIG. 4, the number of resource demander facilities is not limited to one. The demand-supply system model M may have a plurality of resource demander facilities.

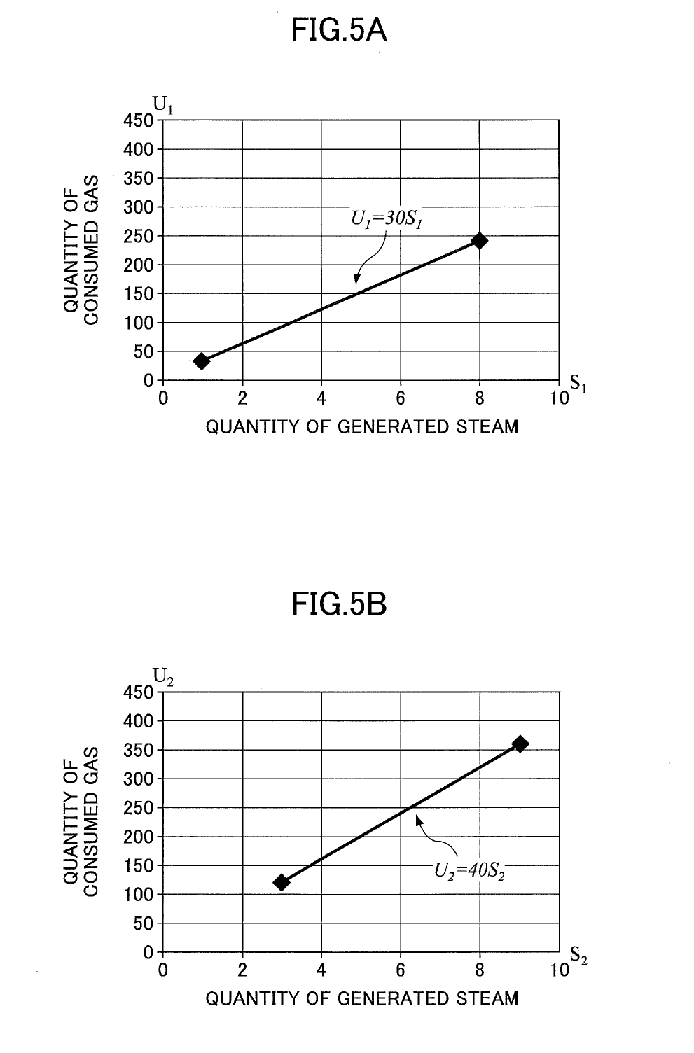

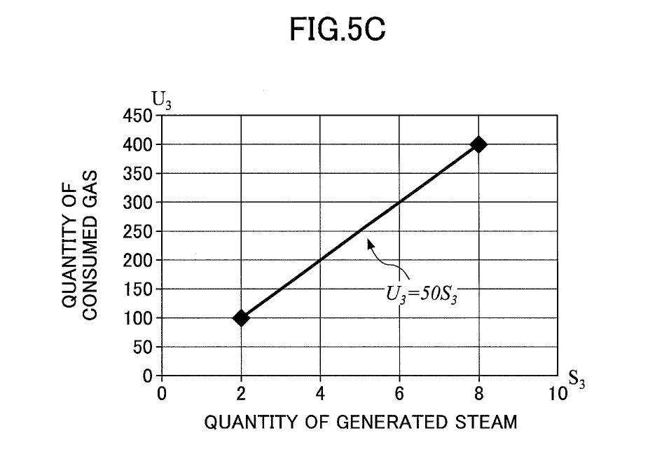

FIG. 5A to 5C illustrate facility capacities of the respective steam generating facilities 1 to 3 in the demand-supply system model M illustrated in FIG. 4. That is, in FIGS. 5A to 5C, quantities of gas, which are consumed in the respective steam generating facilities 1 to 3, are U₁ to U₃ and quantities of steam, which are generated by consuming the gas quantities, are S₁to S₃. At this time, relationships between quantities of consumed gas and quantities of generated steam of the respective steam generating facilities 1 to 3 are illustrated by FIGS. 5A to 5C.

As described above, an objective function and constraint conditions are indicated as follows where variable C represents a total cost and variable L represents a total quantity demanded.

$$\begin{matrix}OBJECTIVE FUNCTION & C \\ & C = {U}_{1} + {U}_{2} + {U}_{3} \\ CONSTRAINT CONDITION & 0 = {U}_{1} - 30 {S}_{1} \\ & 0 = {U}_{2} - 40 {S}_{2} \\ & 0 = {U}_{3} - 50 {S}_{3} \\ & L = {S}_{1} + {S}_{2} + {S}_{3} \\ & {S}_{1} ≧ 1 \\ & {S}_{1} ≦ 8 \\ & {S}_{2} ≧ 3 \\ & {S}_{2} ≦ 9 \\ & {S}_{3} ≧ 2 \\ & {S}_{3} ≦ 8\end{matrix} \qquad < Expression ( s ) 3 >$$

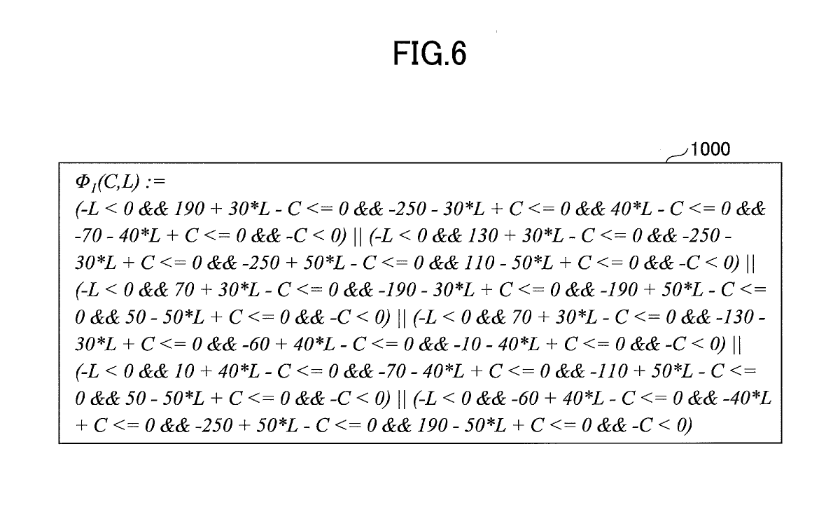

Then, by the method disclosed in International Publication Pamphlet No. WO 2014/129470, after the objective function C and the constraint conditions are coupled to generate a first-order predicate logic expression, a quantifier elimination method is used to eliminate quantifiers from the generated first-order predicate logic expression. In this way, it is possible to obtain Φ₁(C,L), which is the first relational expression 1000 illustrated in FIG. 6. As illustrated in FIG. 6, the first relational expression 1000 is indicated by a logical expression including inequality signs and logical signs. It should be noted that Φ₁(C,L), which is a relational expression between C and L, may be obtained by eliminating, from the first-order predicate logic expression, quantifiers except for C and L.

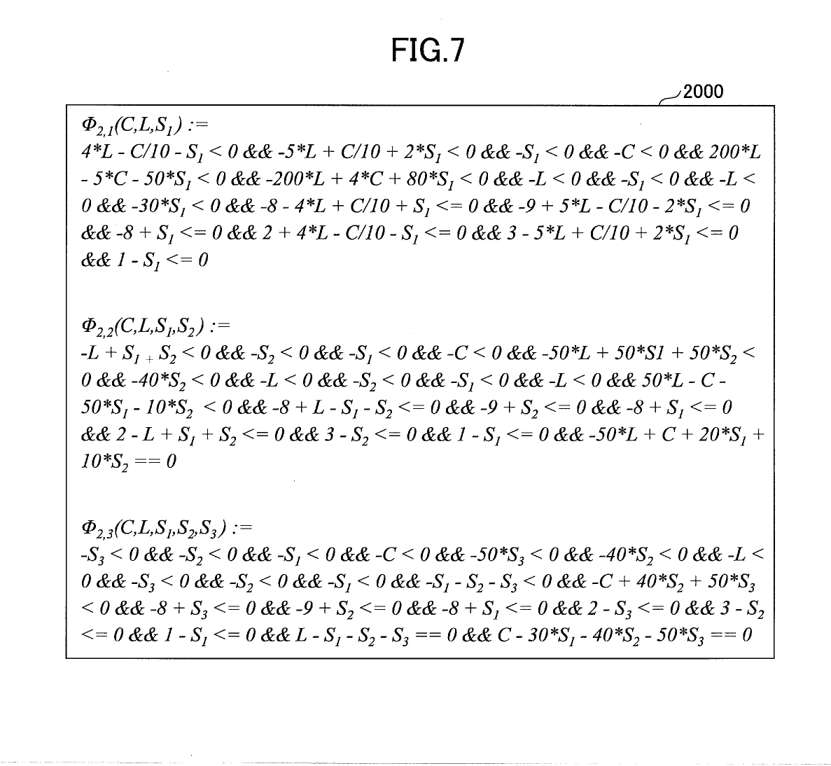

Similarly, Φ_{2,1}(C,L,S₁), Φ_{2,2}(C,L,S₁,S₂), and Φ_{2,3}(C,L,S₁,S₂,S₃), included in the second relational expression group 2000 illustrated in FIG. 7, can be obtained by using a quantifier elimination method to eliminate quantifiers from the first-order predicate and Φ_{2,3} included in the second relational expression group 2000 are indicated by logical expressions including inequality signs and logical signs. It should be noted that Φ_{2,1}(C,L,S₁), which is a relational expression between C, L, and S₁, can be obtained by eliminating, from the first-order predicate logic expression, quantifiers except for C, L, and S₁. Similarly, Φ_{2,2}(C,L,S₁,S₂) can be obtained by eliminating, from the first-order predicate logic expression, quantifiers except for C, L, S₁and S₂. Similarly, Φ_{2,3}(C,L,S₁,S₂,S₃) can be obtained by eliminating, from the first-order predicate logic expression, quantifiers except for C, L, S₁, S₂, and S₃.

In this way, the first relational expression 1000 and the second relational expression group 2000 stored in the control apparatus 10 according to the first embodiment can be created by the method disclosed in International Publication Pamphlet No. WO 2014/129470. For example, after being created previously in a computer such as a PC, the first relational expression 1000 and the second relational expression group 2000 stored in the control apparatus 10 according to the first embodiment are stored in the control apparatus 10.

Thus, according to the control system 100 of the first embodiment, even when there is a restriction of hardware resources of the control apparatus 10, it is possible to cause the control apparatus 10 to perform control such that the respective resource supplying facilities included in the demand-supply system 30 are optimally operated.

<Details of Processing>

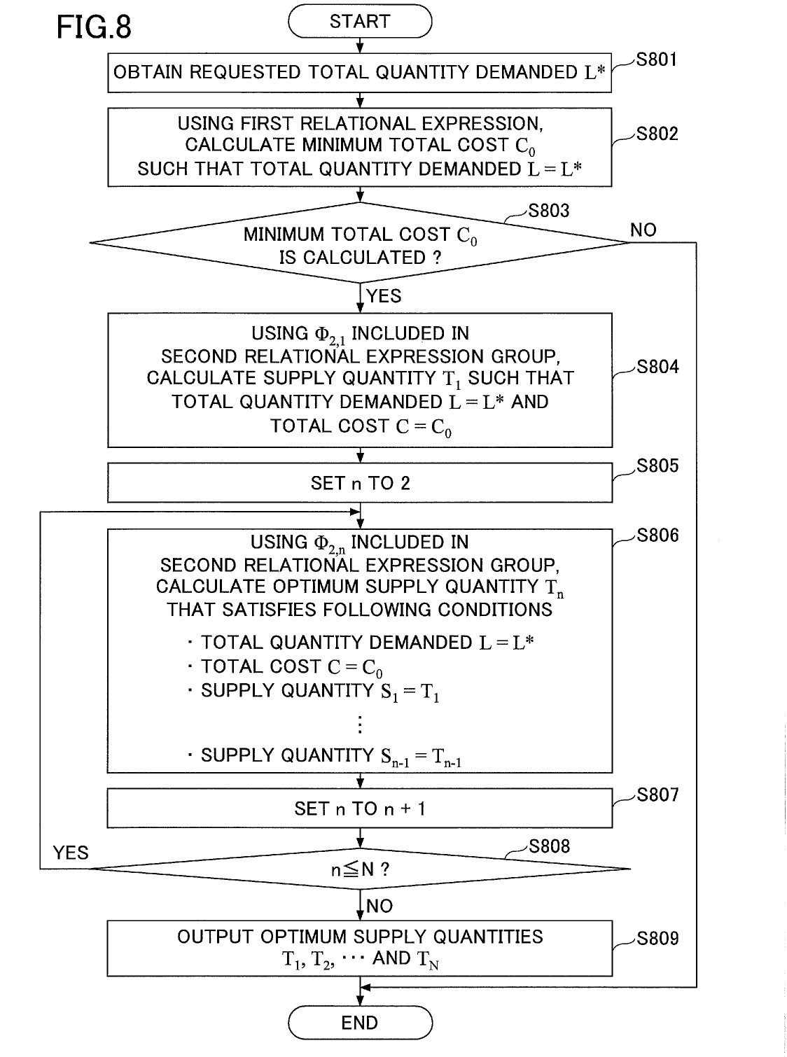

Next, details of processing of determining optimum allocation that is executed in the control apparatus 10 according to the first embodiment will be described with reference to FIG. 8. FIG. 8 is a flowchart illustrating an example of processing of determining optimum allocation according to the first embodiment. Note that in the following descriptions, the demand-supply system 30 is indicated by the demand-supply system model M illustrated in FIG. 4. Accordingly, the demand-supply system 30 includes the resource supplying facilities 1 to 3.

First, the optimum allocation processing unit 110 causes the minimum total cost calculating unit 111 to obtain a requested total demand (requested total quantity demanded) L* in step S801. That is, the minimum total cost calculating unit 111 obtains the requested total demand L* input in the input/output apparatus 20.

Next, using the first relational expression 1000, the optimum allocation processing unit 110 causes the minimum total cost calculating unit 111 to calculate a minimum total cost C₀ necessary for supplying supply quantities, which satisfies the requested total demand L*, to the resource demander facility in step S802.

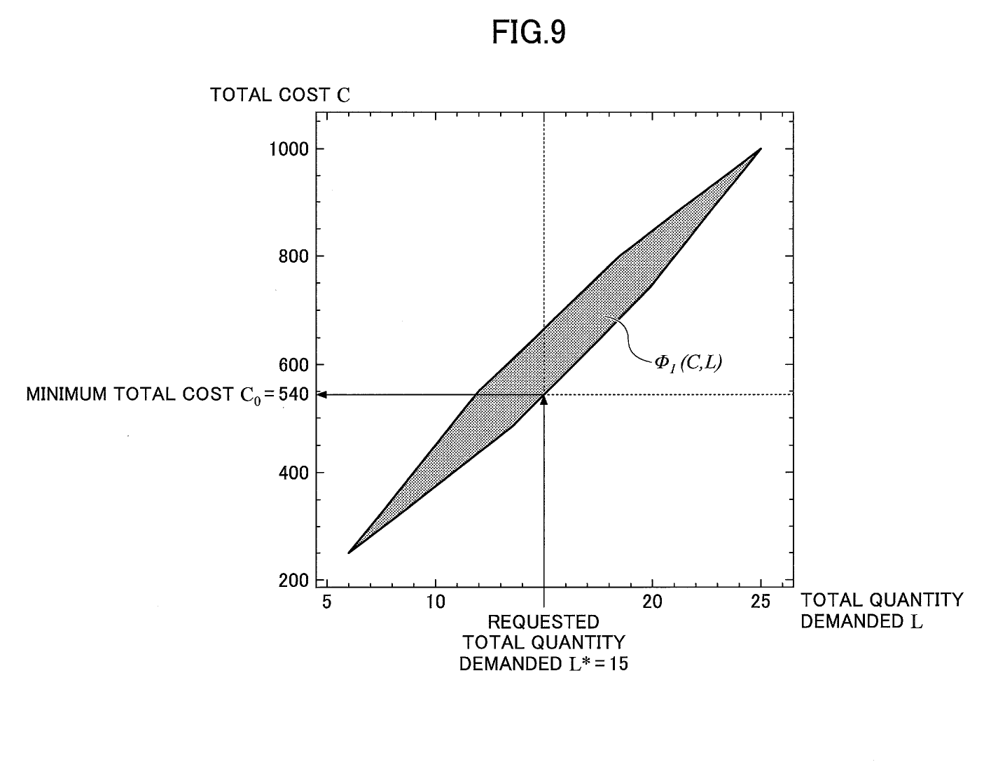

Here, FIG. 9 illustrates an example of calculating the minimum total cost C₀ by use of the first relational expression 1000 illustrated in FIG. 6 in a case where the requested total demand L* is equal to 15. As illustrated in FIG. 9, in a case where the requested total demand L* is equal to 15, the calculated minimum total cost C₀ is equal to 540. For example, this can be calculated by using a binary search method or the like to explore the minimum C, which satisfies Φ₁(C,L*)=1. In other words, upon a total demand of the resources demanded in the resource demander facility being input, the minimum total cost calculating unit 111 may calculate the minimum cost necessary for the resource supplying facilities to supply the resources of the total demand with reference to the graph as illustrated in FIG. 9 that represents the relationship between the total cost and the total demand.

Next, the optimum allocation processing unit 110 determines whether the minimum total cost C₀ is calculated in step S803. That is, the optimum allocation processing unit 110 determines whether the resource supplying facilities included in the demand-supply system 30 can supply the resources that satisfy the requested total demand L* input in the input/output apparatus 20.

In a case where the minimum total cost C₀ is not calculated (NO in step S803), the optimum allocation processing unit 110 finishes the processing. In this case, the respective resource supplying facilities included in the demand-supply system 30 cannot supply the resources, which satisfy the requested total demand L*.

In a case where the minimum total cost C₀ is calculated (YES in step S803), using Φ_{2,1} included in the second relational expression group 2000, the optimum allocation processing unit 110 causes the supply quantity calculating unit 112 to calculate an optimum supply quantity T₁ of a resource supplying facility 1 in step S804. That is, the supply quantity calculating unit 112 uses Φ_{2,1}(C,L,S₁), included in the second relational expression group 2000, to calculate the supply quantity S₁, to be equal to T₁, such that L is equal to L* and C is equal to C₀.

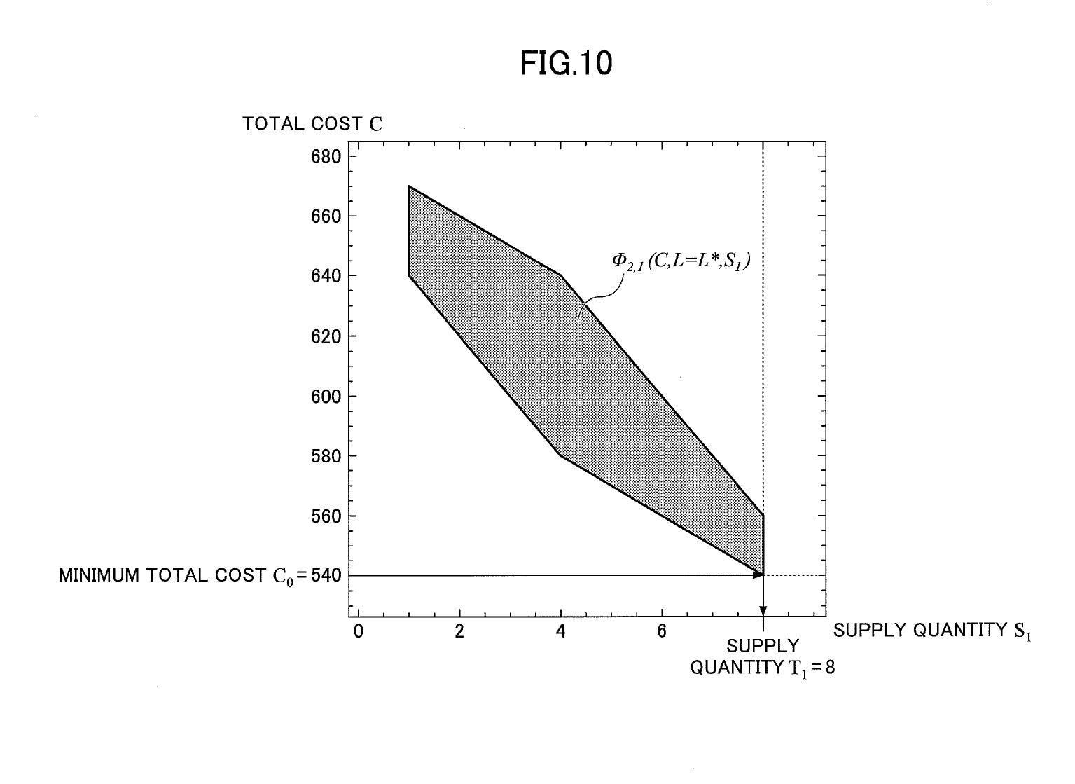

Here, FIG. 10 illustrates an example of calculating the optimum supply quantity T₁ by use of Φ_{2,1} included in the second relational expression group 2000 illustrated in FIG. 7 in a case where the requested total demand L* is equal to 15. As illustrated in FIG. 10, the calculated optimum supply quantity T₁ of the resource supplying facility 1 is equal to 8. For example, this can be calculated by using a binary search method or the like to explore the minimum S₁, which satisfies Φ_{2,1} (C₀,L*,S₁)=1.

Next, the optimum allocation processing unit 110 sets variable n, which represents a respective resource supplying facility, to be 2 in step S805.

Next, using Φ_{2,n} included in the second relational expression group 2000, the optimum allocation processing unit 110 causes the supply quantity calculating unit 112 to calculate an optimum supply quantity Tₙ of a resource supplying facility n in step S806.

That is, for example, in a case where n is equal to 2, the supply quantity calculating unit 112 uses Φ_{2,2}(C,L,S₁,S₂), included in the second relational expression group 2000, to calculate the supply quantity S₂, to be equal to T₂, such that L is equal to L*, C is equal to C₀, and S₁is equal to T₁.

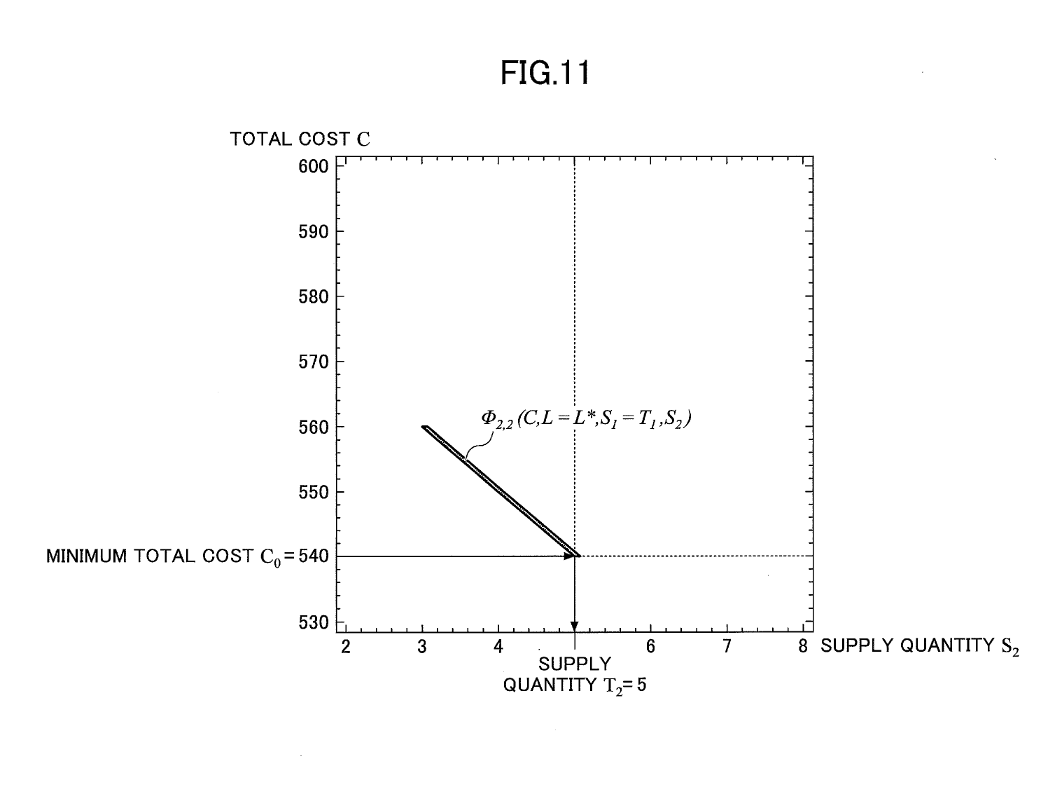

Here, FIG. 11 illustrates an example of calculating the optimum supply quantity T₂ by use of Φ_{2,2} included in the second relational expression group 2000 illustrated in FIG. 7 in the case where the requested total demand L* is equal to 15. As illustrated in FIG. 11, the calculated optimum supply quantity T₂ of the resource supplying facility 2 is equal to 5. For example, this can be calculated by using the binary search method or the like to explore the minimum S₂, which satisfies Φ_{2,2}(C₀,L*,T₁,S₂)=1.

Further, in a case were n is equal to 3, for example, the supply quantity calculating unit 112 uses Φ_{2,3}(C,L,S₁,S₂,S₃), included in the second relational expression group 2000, to calculate the supply quantity S₃, to be equal to T₃, such that L is equal to L*, C is equal to C₀, S₁ is equal to T₁, and S₂ is equal to T₂.

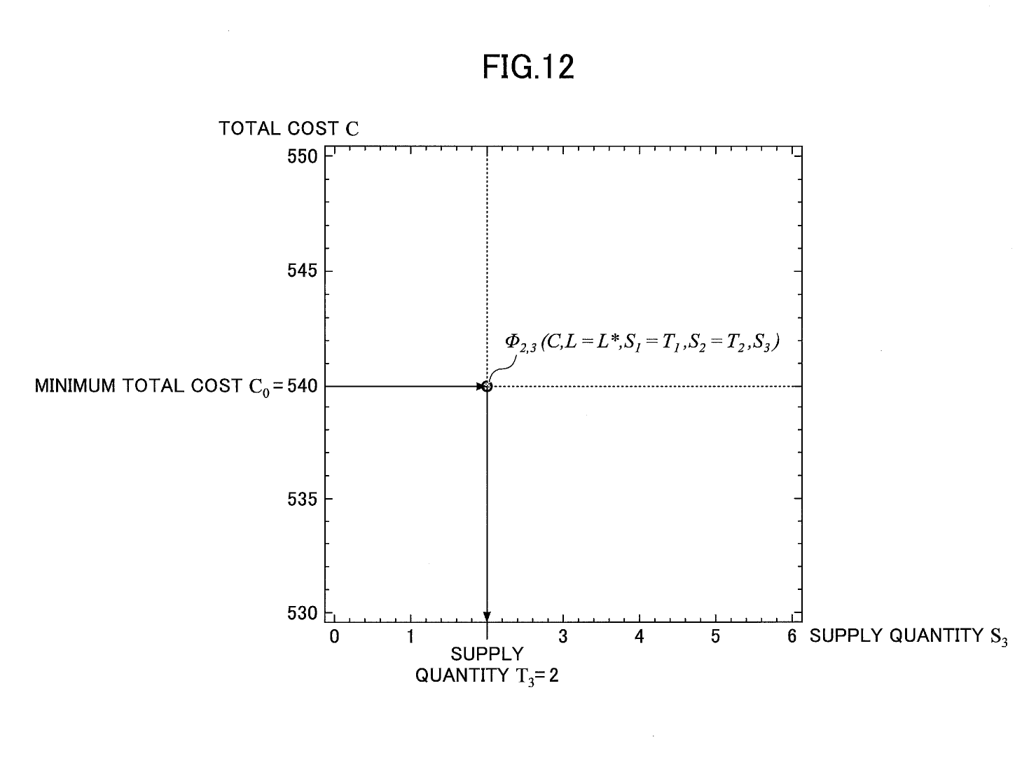

Here, FIG. 12 illustrates an example of calculating the optimum supply quantity T₃ by use of Φ_{2,3} included in the second relational expression group 2000 illustrated in FIG. 7 in the case where the requested total demand L* is equal to 15. As illustrated in FIG. 12, the calculated optimum supply quantity T₃ of the resource supplying facility 3 is equal to 2. For example, this can be calculated by using the binary search method or the like to explore the minimum S₃, which satisfies Φ_{2,3}(C₀,L*,T₁,T₂,S₃)=1.

Next, the optimum allocation processing unit 110 sets variable n, which represents a respective resource supplying facility, to be n+1 in step S807. That is, the optimum allocation processing unit 110 increments the value of variable n by one.

Next, the optimum allocation processing unit 110 determines whether n is less than or equal to N in step S808 where the number of resource supplying facilities included in the demand-supply system 30 is N.

In a case where the optimum allocation processing unit 110 has determined that n is less than or equal to N (YES in step S808), the optimum allocation processing unit 110 returns the processing to step S806. That is, the optimum allocation processing unit 110 calculates an optimum supply quantity Tₙ of a resource supplying facility n.

In this way, the optimum allocation processing unit 110 calculates the optimum supply quantity Tₙ (n=1, 2, . . . , N) of the respective resource supplying facility n (n=1, 2, . . . , N). Note that, in a case where the demand-supply system 30 is indicated by the demand-supply system model M, N is equal to 3. In other words, with reference to the graphs as illustrated in FIGS. 5A to 5C that represent the capacities of the respective resource supplying facilities to supply the resources, the optimum allocation processing unit 110 may calculate the optimum supply quantities, to be supplied from the respective resource supplying facilities to the resource demander facility, such that the resource supplying facilities supply the resources of the total demand at the minimum cost. Here, the optimum allocation processing unit 110 may calculate a supply quantity of the resources to be supplied from at least one resource supplying facility of the plurality of resource supplying facilities.

In a case where the optimum allocation processing unit 110 has determined that n is not N or less (NO in step S808), the optimum allocation processing unit 110 outputs, to the control processing unit 120 in step S809, the optimum supply quantities T₁ to T_{N} of the respective resource supplying facilities 1 to N as calculated above. Thus, the control processing unit 120 can control the respective resource supplying facilities 1 to N such that the supply quantities of the respective resource supplying facilities 1 to N, included in the demand-supply system 30, are T₁ to T_{N}.

As described above, the control system 100 according to the first embodiment can determine the allocation of the optimum supply quantities of the respective resource supplying facilities included in the demand-supply system 30 by use of the first relational expression 1000 and the second relational expression group 2000 previously stored in the control apparatus 10.

For example, the control apparatus 10, which includes a device memory that stores at least one program and at least one processor that executes the at least one program to execute processing as described above, may control a demand-supply system as illustrated in FIG. 3. Specifically, the processing, executed by the control apparatus 10, includes calculating, based on a total demanded quantity of steam demanded by the steam using facility, a minimum total quantity of gas necessary for the steam generating facilities 1 to 3 to supply the steam of the total demanded quantity, with reference to data, which is as illustrated in FIG. 9, on a relationship between the total demanded quantity of the steam and the minimum total quantity of the gas. Further, the processing includes calculating respective quantities of the steam to be supplied from the steam generating facilities 1 to 3 to the steam using facility based on the total demanded quantity of the steam, the minimum total quantity of the gas, and capacities, which are as illustrated in FIGS. 5A to 5C, of the respective steam generating facilities 1 to 3 to use the gas to supply the steam. Further, the processing includes causing the steam generating facilities 1 to 3 to supply the respective quantities of the steam to the steam using facility such that total demanded quantity of the steam, demanded by the steam using facility, is supplied to the steam using facility.

Moreover, according to the control system 100 of the first embodiment, it is sufficient for the control apparatus 10 to have a memory that can store the first relational expression 1000 and the second relational expression group 2000, and even an inexpensive CPU or the like can calculate optimum supply quantities because the optimum supply quantities are calculated by the binary search method or the like. Thus, in the control system 100 according to the first embodiment, various devices such as a Programmable Logic Controller (PLC) and an embedded device may be used as the control apparatus 10.

Further, according to the control system 100 of the first embodiment, a server apparatus or the like for determining allocation of optimum supply quantities of respective resource supplying facilities becomes unnecessary, and cost required for a system structure can be reduced. Furthermore, according to the control system 100 of the first embodiment, it is possible to prevent a readiness (response property) of control being decreased due to a network delay or the like, for example, because the server apparatus or the like becomes unnecessary as described above.

### Second Embodiment

Next, a second embodiment will be described. In the descriptions of the second embodiment, differences between the second embodiment and the first embodiment will be mainly described. Reference numerals, similar to the reference numerals used in the descriptions of the first embodiment, are given to parts of the second embodiment, which have functions substantially similar to those of the first embodiment, and parts of the second embodiment, which execute processing substantially similar to that of the first embodiment, such that and their descriptions may be omitted as appropriate.

<System Configuration>

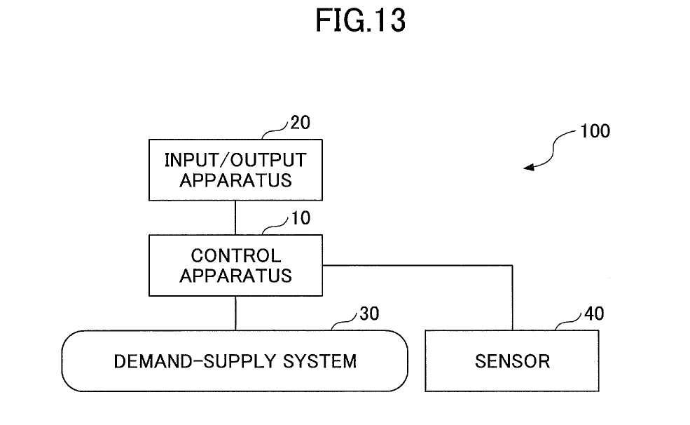

First, a system configuration of a control system 100 according to the second embodiment will be described with reference to FIG. 13. FIG. 13 is a block diagram illustrating an example of the system configuration of the control system 100 according to the second embodiment.

The control system 100 illustrated in FIG. 13 further includes a sensor 40. The sensor 40 is a measuring device that measures at least one external condition with respect to the demand-supply system 30. For example, the external condition may be an ambient temperature (outside air temperature), a water temperature, and/or the like. As described above, the control system 100 according to the second embodiment includes the sensor 40 that measures (detects) at least one external condition of the demand-supply system 30. Then, the control system 100 according the second embodiment causes the control apparatus 10 to determine optimum allocation of supply quantities of resources of the respective resource supplying facilities in consideration of the external condition.

Other than the ambient temperature and the water temperature, the external condition may include at least one of humidity, a pressure (air pressure, fluid pressure), a flow rate (gas, liquid), current, voltage, a light amount, solar radiation, a wind speed, and a vibration frequency, for example.

<Functional Configuration>

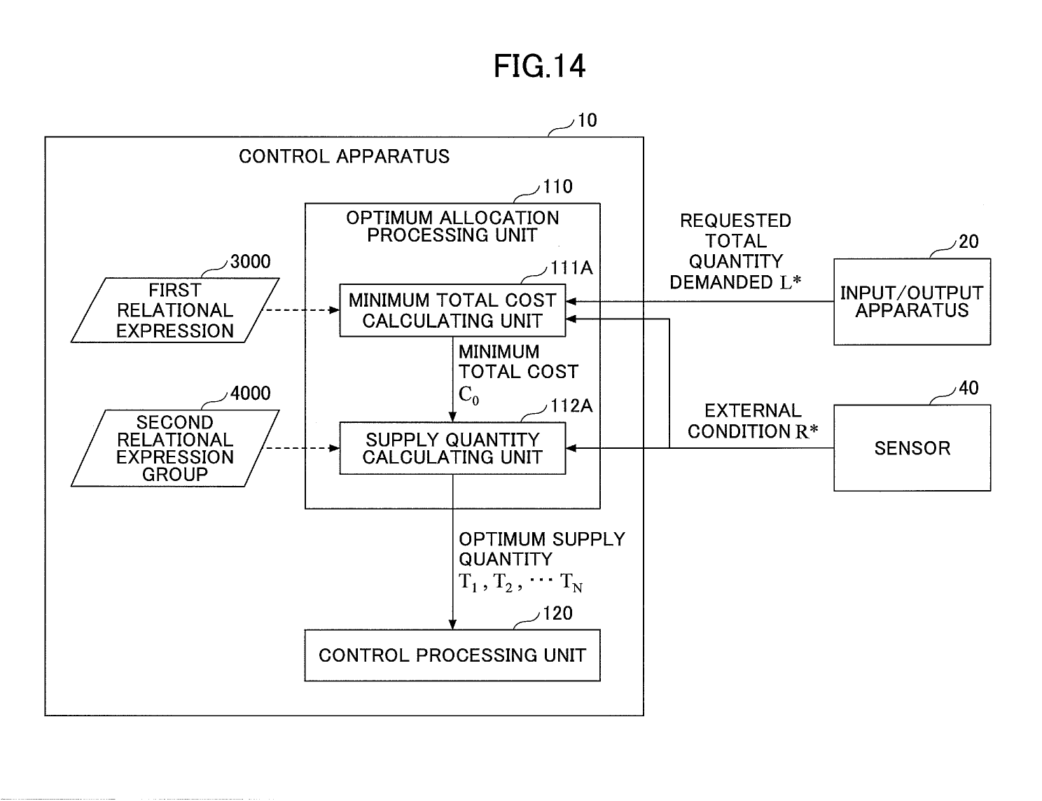

Next, a functional configuration of the control apparatus 10 according to the second embodiment will be described with reference to FIG. 14. FIG. 14 is a block diagram illustrating an example of the functional configuration of the control apparatus 10 according to the second embodiment.

The optimum allocation processing unit 110 of the control apparatus 10 illustrated in FIG. 13 includes a minimum total cost calculating unit 111A and a supply quantity calculating unit 112A. Further, the control apparatus 10 includes a first relational expression 3000 and a second relational expression group 4000.

The minimum total cost calculating unit 111A obtains a requested total demand (requested total quantity demanded) L*, input in the input/output apparatus 20, and an external condition R* measured in the sensor 40. Then, using the first relational expression 3000, the minimum total cost calculating unit 111A calculates a minimum total cost C₀ necessary for supplying, to a resource demander facility, supply quantities, which satisfies the requested total demand L* and the external condition R*.

Upon the minimum total cost C₀ being calculated by the minimum total cost calculating unit 111A, the supply quantity calculating unit 112A uses to the second relational expression 4000 to calculate optimum supply quantities for the respective resource supplying facilities that satisfy the external condition R*.

The first relational expression 3000 is an expression that describes a relationship between variable L, which represents a total demand (total quantity demanded), variable C, which represents a total cost, and variable R, which represents an external condition. That is, the first relational expression 3000 is a Boolean-Valued function, which can take true or false as a function value, and is indicated as follows.

Φ₁(R,C,L)=true or false <Expression 4>

C: TOTAL COST

L: TOTAL QUANTITY DEMANDED

R: EXTERNAL CONDITION

The second relational expression group 4000 is a set of expressions that describe relationships between variable C, which represents the total cost, variable L, which represents the total demand, and variables S₁to S_{N}, which represent supply quantities of the respective resource supplying facilities. In other words, the expressions of the second relational expression group 4000 represent, for the respective resource supplying facilities, relationships between the total cost, the total demand, the external condition, and the supply quantities (supply capacities) of the resource supplying facilities. That is, similar to the first relational expression 3000, the second relational expression group 4000 is a set of Boolean-Valued functions, which can take true or false as a function value, and is indicated as follows.

$${Φ}_{2 , 1} ( R , C , L , {S}_{1} ) = true or false \\ {Φ}_{2 , 2} ( R , C , L , {S}_{1} , {S}_{2} ) = true or false \\ ⋮ \\ {Φ}_{2 , N} ( R , C , L , {S}_{1} , {S}_{2} , … , {S}_{N} ) = true or false \\ C \text{:} TOTAL COST \\ L \text{:} TOTAL QUANTITY DEMAND \\ {S}_{1} \text{:} SUPPLY QUANTITY \\ OF RESOURCE SUPPLYING \\ FACILITY 1 \\ {S}_{2} \text{:} SUPPLY QUANTITY \\ OF RESOURCE SUPPLYING \\ FACILITY 2 \\ ⋮ \\ {S}_{N} \text{:} SUPPLY QUANTITY OF RESOURCE SUPPLYING \\ FACILITY N \\ R \text{:} EXTERNAL CONDITION \qquad < Expression ( s ) 5 >$$

For example, the first relational expression 3000 and the second relational expression group 4000 are previously created in a computer such as a PC. The first relational expression 3000 and the second relational expression group 4000 are previously created by the method disclosed in International Publication Pamphlet No. WO 2014/129470 based on the demand-supply system model, which indicates the demand-supply system 30, and facility capacities of the respective resource supplying facilities.

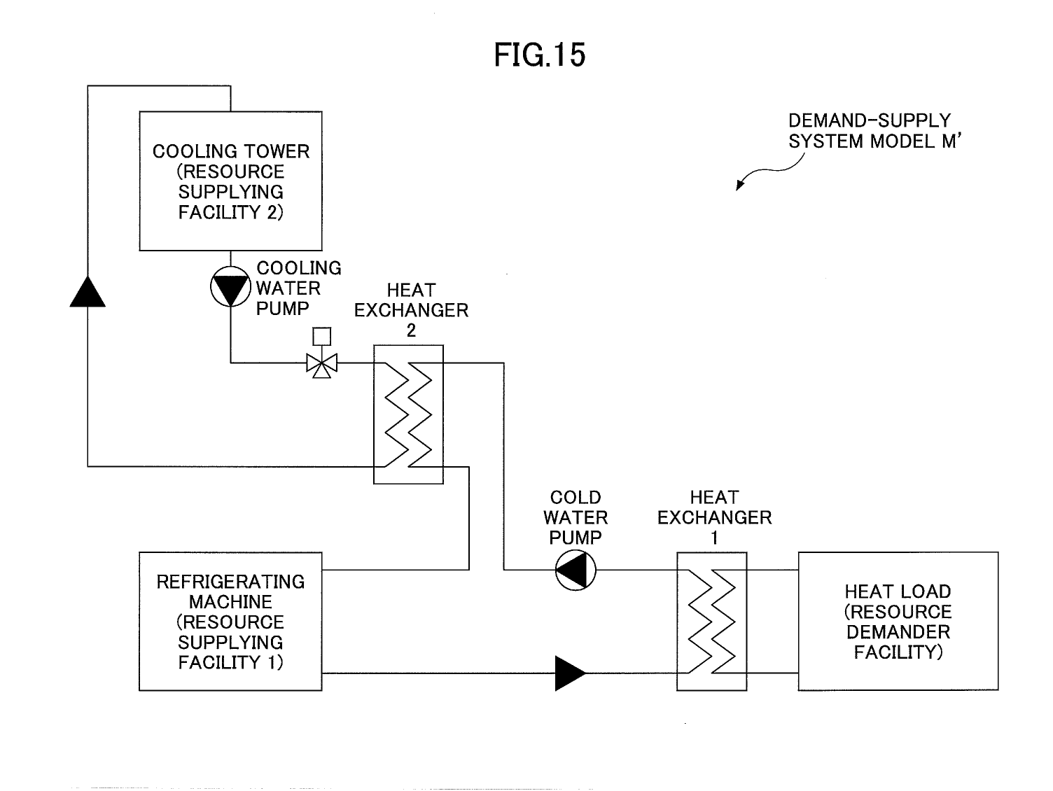

Here, a specific example of the first relational expression 3000 and the second relational expression group 4000 created in the computer such as the PC will be described, for example. First, FIG. 15 illustrates a demand-supply system model M′, which indicates the demand-supply system 30. That is, in the demand-supply system model M′ illustrated in FIG. 15, cold energy (cold heat) is supplied from a refrigerating machine and a cooling tower via a cooling water pump and a cold water pump, and the cold energy is demanded by a heat load. It should be noted that in the cooling water pump, the cold water pump, the refrigerating machine, and the cooling tower, electric power is consumed to supply the cold energy.

Here, each of the refrigerating machine and the cooling tower is a “resource supplying facility”, and the heat load is a “resource demander facility”. Further, the electric power, which is consumed in the refrigerating machine, the cooling tower, the cooling water pump, and the cold water pump, is a “cost”, and the cold energy, which is supplied from the refrigerating machine and the cooling tower, is a “resource”.

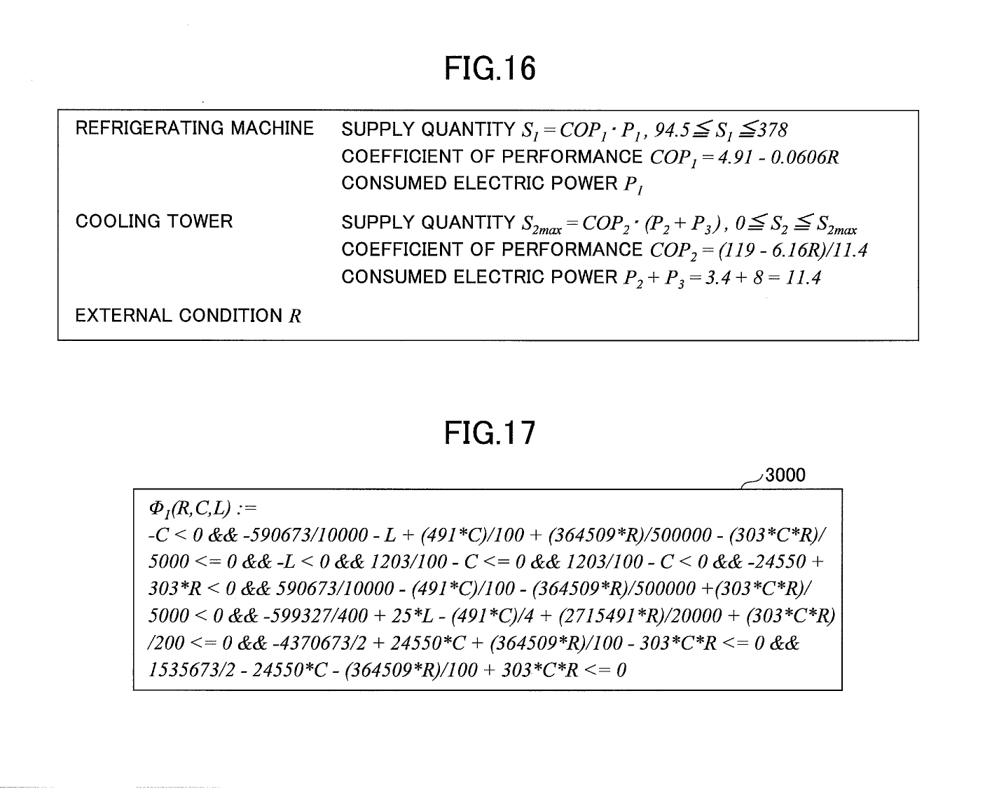

FIG. 16 illustrates facility capacities of the refrigerating machine and the cooling tower in the demand-supply system model M′ illustrated in FIG. 15. That is, P₁ represents electric power that is consumed in the refrigerating machine. P₂ represents electric power that is consumed in the cooling tower. P₃ represents electric power that is consumed in the cooling water pump. P₄ represents electric power that is consumed in the cold water pump. S₁ represents a quantity of cold energy that is supplied from the refrigerating machine. S₂ represents a quantity of cold energy that is supplied from the cooling tower. Here, the supply quantities S₁ and S₂ are respectively indicated by relational expressions illustrated in FIG. 16. Here, COP₁ and COP₂ are respectively coefficients of performance of the refrigerating machine and the cooling tower.

As described above, an objective function and constraint conditions are indicated as follows where variable C represents a total cost and variable L represents a total quantity demanded.

$$\begin{matrix}OBJECTIVE & C \\ FUNCTION & C = {P}_{1} + {P}_{2} + {P}_{3} + {P}_{4} \\ CONSTRAINT & 0 = {COP}_{1} \cdot {P}_{1} - {S}_{1} \\ CONDITION & 0 = {COP}_{2} \cdot ( {P}_{2} + {P}_{3} ) - {S}_{2 max} \\ & L = {S}_{1} + {S}_{2} \\ & {S}_{1} ≧ 94.5 \\ & {S}_{1} ≦ 378 \\ & {S}_{2} ≧ 0 \\ & {S}_{2} ≦ {S}_{2 max} \\ & {COP}_{1} = 4.91 - 0.0606 R \\ & {COP}_{2} = ( 119 - 6.16 R ) / 11.4 \\ & {P}_{2} + {P}_{3} = 11.4 \\ & {P}_{4} = 0.063\end{matrix} \qquad < Expression ( s ) 6 >$$

Then, in a manner similar to that of the first embodiment, by the method disclosed in International Publication Pamphlet No. WO 2014/129470, after the objective function C and the constraint conditions are coupled to generate a first-order predicate logic expression, a quantifier elimination method is used to eliminate quantifiers from the generated first-order predicate logic expression. In this way, it is possible to obtain Φ₁(R,C,L), which is the first relational expression 3000 illustrated in FIG. 17. It should be noted that Φ₁(R,C,L), which is a relational expression between R, C, and L, may be obtained by eliminating, from the first-order predicate logic expression, quantifiers except for R, C, and L.

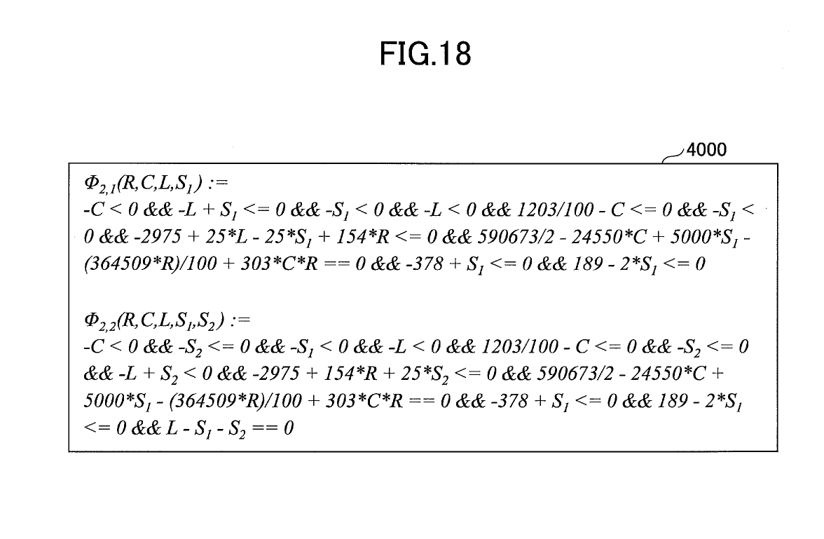

Similarly, Φ_{2,1}(R,C,L,S₁) and Φ_{2,2}(R,C,L,S₁,S₂) included in the second relational expression group 4000 illustrated in FIG. 18, can be obtained by using the quantifier elimination method to eliminate quantifiers from the first-order predicate logic expression. It should be noted that Φ_{2,1}(R,C,L,S₁), which is a relational expression between R, C, L, and S₁can be obtained by eliminating, from the first-order predicate logic expression, quantifiers except for R, C, L, and S₁. Similarly, Φ_{2,2}(R,C,L,S₁,S₂) can be obtained by eliminating, from the first-order predicate logic expression, quantifiers except for R, C, L, S₁and S₂.

<Details of Processing>

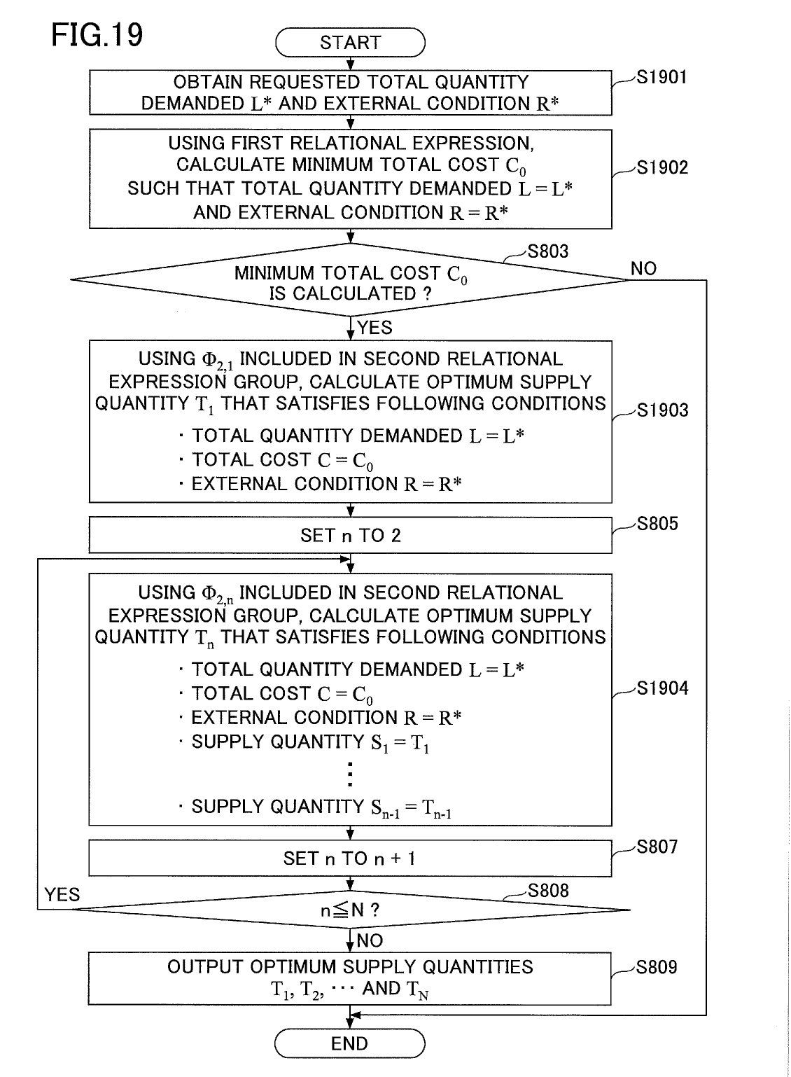

Next, details of processing of determining optimum allocation that is executed in the control apparatus 10 according to the second embodiment will be described with reference to FIG. 19. FIG. 19 is a flowchart illustrating an example of processing of determining optimum allocation according to the second embodiment.

In the processing of determining the optimum allocation illustrated in FIG. 19, because processes in steps S803, S805, and S807 to S809 are similar to the processes of the first embodiment, their descriptions are omitted. Note that in the following descriptions, the demand-supply system 30 is indicated by the demand-supply system model M′ illustrated in FIG. 15. Accordingly, the demand-supply system model includes the resource supplying facilities 1 and 2.

First, the optimum allocation processing unit 110 causes the minimum total cost calculating unit 111A to obtain a requested total demand (requested total quantity demanded) L* and an external condition R* in step S1901. That is, the minimum total cost calculating unit 111 obtains the requested total demand L*, input in the input/output apparatus 20, and the external condition R*, measured in the sensor 40.

Next, using the first relational expression 3000, the optimum allocation processing unit 110 causes the minimum total cost calculating unit 111A to calculate a minimum total cost C₀ necessary for supplying supply quantities, which satisfies the requested total demand L* and the external condition R*, in step S1902.

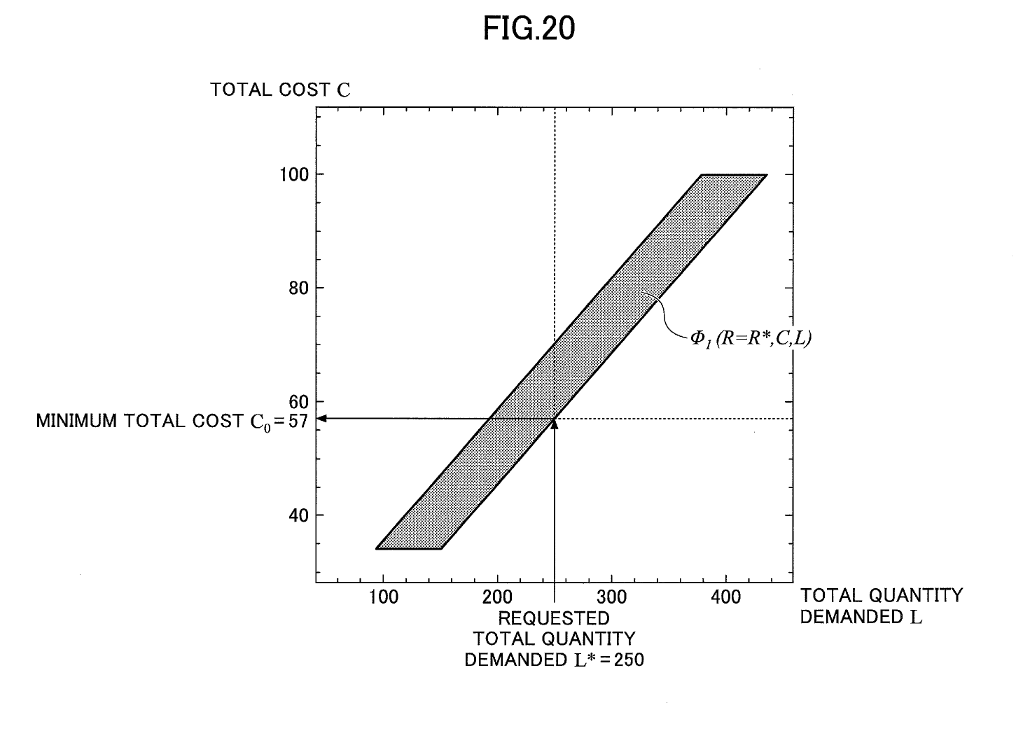

Here, FIG. 20 illustrates an example of calculating the minimum total cost C₀ by use of the first relational expression 3000 illustrated in FIG. 17 in a case where the requested total demand L* is equal to 250 and the external condition R* is equal to 10. As illustrated in FIG. 20, in the case where the requested total demand L* is equal to 250 and the external condition R* is equal to 10, the calculated minimum total cost C₀ is equal to 57. For example, this can be calculated by using the binary search method or the like to explore the minimum C, which satisfies Φ₁(R*,C,L*)=1.

In a case where the minimum total cost C₀ is calculated (YES in step S803), using Φ_{2,1} included in the second relational expression group 4000, the optimum allocation processing unit 110 causes the supply quantity calculating unit 112A to calculate an optimum supply quantity T₁ of a resource supplying facility 1 in step S1904. That is, the supply quantity calculating unit 112 uses Φ_{2,1}(R,C,L,S₁), included in the second relational expression group 4000, to calculate the supply quantity S₁, to be equal to T₁, such that R is equal to R*, L is equal to L*, and C is equal to C₀.

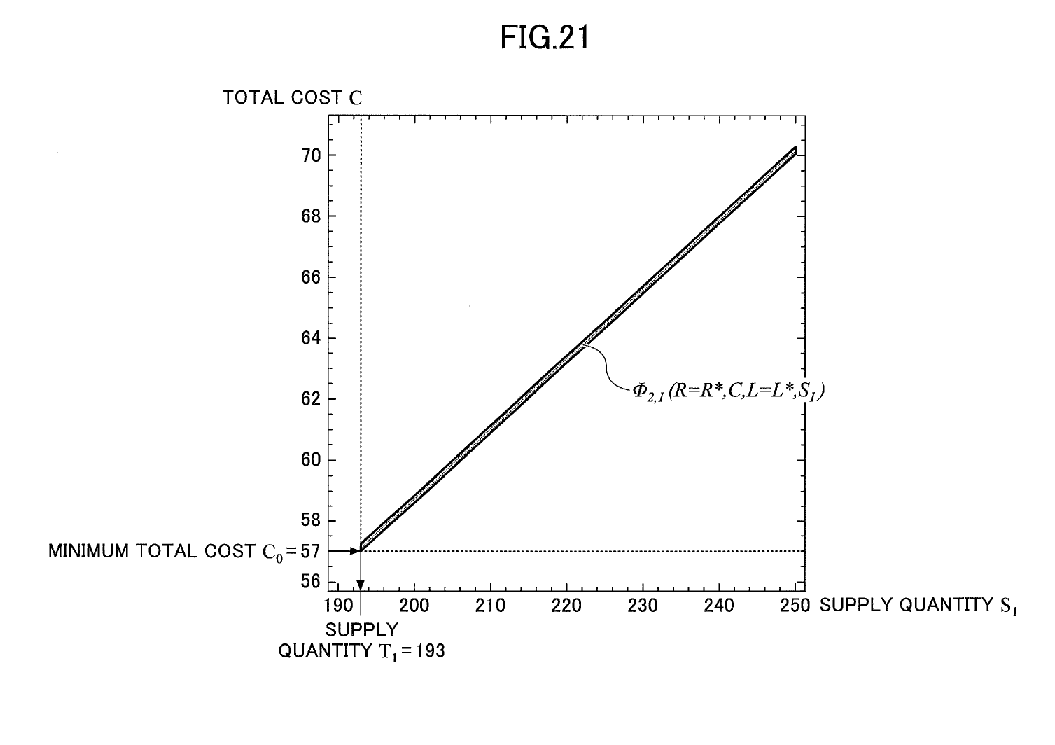

Here, FIG. 21 illustrates an example of calculating the optimum supply quantity T₁ by use of 0₂,₁ included in the second relational expression group 4000 illustrated in FIG. 18 in the case where the requested total demand L* is equal to 250 and the external condition R* is equal to 10. As illustrated in FIG. 21, the calculated optimum supply quantity T₁ of the resource supplying facility 1 is equal to 193. For example this can be calculated by using the binary search method or the like to explore the minimum S₁, which satisfies Φ_{2,1}(R*,C₀,L*, S₁)=1.

Next, using Φ_{2,n} included in the second relational expression group 4000, the optimum allocation processing unit 110 causes the supply quantity calculating unit 112A to calculate an optimum supply quantity Tₙ of a resource supplying facility n in step S1904.

That is, for example, in a case where n is equal to 2, the supply quantity calculating unit 112A uses Φ_{2,2}(R,C,L,S₁,S₂), included in the second relational expression group 4000, to calculate the supply quantity S₂, to be equal to T₂, such that R is equal to R*, L is equal to L*, C is equal to C₀, and S₁is equal to T₁.

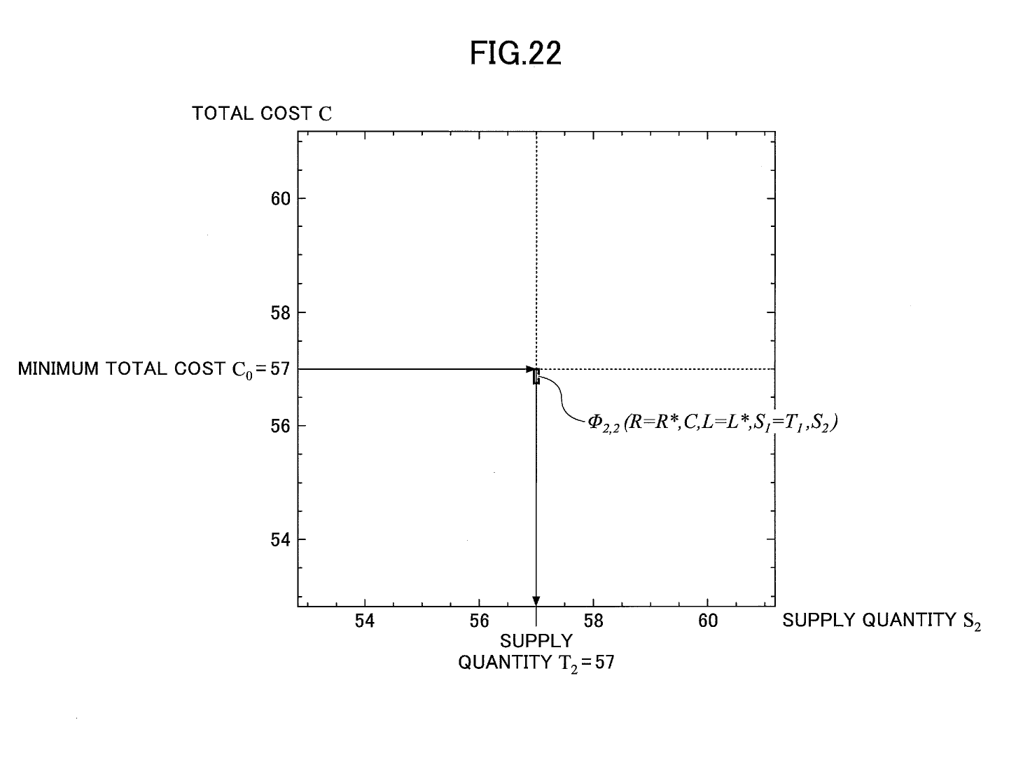

Here, FIG. 22 illustrates an example of calculating the optimum supply quantity T₂ by use Φ_{2,2} included in the second relational expression group 4000 illustrated in FIG. 18 in the case where the requested total demand L* is equal to 250 and the external condition R* is equal to 10. As illustrated in FIG. 22, the calculated optimum supply quantity T₂ of the resource supplying facility 2 is equal to 57. For example, this can be calculated by using the binary search method or the like to explore the minimum S₂, which satisfies Φ_{2,2}(R*,C₀,L*,T₁, S₂)=1.

In this way, the optimum allocation processing unit 110 calculates, in consideration of the value of variable R representing the external condition, the optimum supply quantity Tₙ (n=1, 2, . . . , N) of the respective resource supplying facility n (n=1, 2, . . . , N).

As described above, the control system 100 according to the second embodiment determines, in consideration of the external condition, the allocation of the optimum supply quantities of the respective resource supplying facilities included in the demand-supply system 30. Therefore, according to the control system 100 of the second embodiment, it is possible to determine the allocation of the optimum supply quantities even when the total cost fluctuates in accordance with the external condition, for example. In other words, it is possible to determine the allocation when variable C, which represents the total cost, also depends on variable R, which represents the external condition.

According to one embodiment of the present invention, it is possible to determine optimum allocation in various devices.

It should be noted that the above described apparatus according to the embodiments may be realized by a device memory, which stores at least one program, and by at least one processor, which executes the at least one program to execute processing as described in the embodiments. In other words, the control apparatus 10 may be realized by the device memory and the at least one processor, for example. For example, the device memory and the at least one processor can implement functions as described in the embodiments and may be implemented by hardware elements as described in the embodiments. The at least one program for causing the control apparatus 10 to execute processing as described above may be stored in a computer-readable recording medium.

The present invention is not limited to the specifically described embodiments, but various variations and modifications may be made without departing from the scope of the present invention.

What is claimed is:

1. A control apparatus for controlling a demand-supply system, the demand-supply system including a plurality of resource supplying facilities configured to supply resources and at least one resource demander facility configured to demand the resources supplied from the plurality of resource supplying facilities, the control apparatus comprising:
a minimum cost calculating unit configured to calculate, upon a total demand of the resources demanded in the at least one resource demander facility being input, a minimum cost necessary for the plurality of resource supplying facilities to supply the resources of the total demand based on the total demand and a cost necessary for the plurality of resource supplying facilities to supply the resources; and
a supply quantity calculating unit configured to calculate optimum supply quantities of the respective resource supplying facilities based on the minimum cost, calculated by the minimum cost calculating unit, the total demand, and a supply quantity of the resources to be supplied from at least one resource supplying facility of the plurality of resource supplying facilities.

2. The control apparatus according to claim 1,
wherein the minimum cost calculating unit uses first information, which represents a relationship between the total demand and the cost necessary for the plurality of resource supplying facilities to supply the resources, to calculate the minimum cost upon the total demand of the resources demanded in the at least one resource demander facility being input, and
wherein the supply quantity calculating unit uses a plurality of sets of second information, which represent relationships between the minimum cost, the total demand, and the supply quantity of the resources to be supplied from the at least one resource supplying facility of the plurality of resource supplying facilities, to calculate the optimum supply quantities of the respective resource supplying facilities upon the minimum cost being calculated by the minimum cost calculating unit.

3. The control apparatus according to claim 2, wherein the plurality of sets of second information represent, for the respective plurality of resource supplying facilities, relationships between the minimum cost, the total demand, and supply quantities of the resources to be supplied from the plurality of resource supplying facilities.

4. The control apparatus according to claim 2, wherein the first information and the plurality of sets of second information are created by another apparatus, which is different from the control apparatus, based on information representing respective supply capacities of the plurality of resource supplying facilities to supply the resources and a model representing the demand-supply system.

5. The control apparatus according to claim 1,
wherein the minimum cost calculating unit calculates, upon the total demand of the resources demanded in the at least one resource demander facility and an external condition in the demand-supply system being input, the minimum cost necessary for the plurality of resource supplying facilities to supply the resources of the total demand based on the external condition, the total demand, and the cost necessary for the plurality of resource supplying facilities to supply the resources, and
wherein the supply quantity calculating unit calculates the optimum supply quantities of the respective resource supplying facilities based on the external condition, the minimum cost, calculated by the minimum cost calculating unit, the total demand, and the supply quantity of the resources to be supplied from the at least one resource supplying facility of the plurality of resource supplying facilities.

6. The control apparatus according to claim 5,
wherein, the minimum cost calculating unit uses third information, which represents a relationship between the external condition, the total demand, and the cost necessary for the plurality of resource supplying facilities to supply the resources, to calculate the minimum cost upon the total demand of the resources demanded in the at least one resource demander facility and the external condition in the demand-supply system being input,
wherein the supply quantity calculating unit uses a plurality of sets of fourth information, which represent relationships between the external condition, the minimum cost, the total demand, and the supply quantity of the resources to be supplied from the at least one resource supplying facility of the plurality of resource supplying facilities, to calculate the optimum supply quantities of the respective resource supplying facilities upon the minimum cost being calculated by the minimum cost calculating unit.

7. The control apparatus according to claim 6, wherein the plurality of sets of fourth information represent, for the respective of the plurality of resource supplying facilities, relationships between the external condition, the minimum cost, the total demand, and supply quantities of the plurality of resource supplying facilities.

8. A control system comprising:
the control apparatus according to claim 1; and
an input/output apparatus configured to input the total demand of the resources demanded in the at least one resource demander facility.

9. A control system comprising:
the control apparatus according to claim 1;
an input/output apparatus configured to input the total demand of the resources demanded in the at least one resource demander facility; and
a measuring apparatus configured to measure an external condition in the demand-supply system,
wherein the minimum cost calculating unit calculates, upon the total demand being input and the external condition being measured, the minimum cost necessary for the plurality of resource supplying facilities to supply the resources of the total demand based on the external condition, the total demand, and the cost necessary for the plurality of resource supplying facilities to supply the resources, and
wherein the supply quantity calculating unit calculates the optimum supply quantities of the respective resource supplying facilities based on the external condition, the minimum cost, calculated by the minimum cost calculating unit, the total demand, and the supply quantity of the resources to be supplied from the at least one resource supplying facility of the plurality of resource supplying facilities.

10. A computer-readable recording medium storing a program for causing a control apparatus for controlling a demand-supply system to execute processing, the demand-supply system including a plurality of resource supplying facilities configured to supply resources and at least one resource demander facility configured to demand the resources supplied from the plurality of resource supplying facilities, the processing comprising:
calculating, upon a total demand of the resources demanded in the at least one resource demander facility being input, a minimum cost necessary for the plurality of resource supplying facilities to supply the resources of the total demand based on the total demand and a cost necessary for the plurality of resource supplying facilities to supply the resources; and
calculating optimum supply quantities of the respective resource supplying facilities based on the minimum cost, calculated by the minimum cost calculating unit, the total demand, and a supply quantity of the resources to be supplied from at least one resource supplying facility of the plurality of resource supplying facilities.

11. A control method used in a control apparatus for controlling a demand-supply system, the demand-supply system including a plurality of resource supplying facilities configured to supply resources and at least one resource demander facility configured to demand the resources supplied from the plurality of resource supplying facilities, the control method comprising:
calculating, upon a total demand of the resources demanded in the at least one resource demander facility being input, a minimum cost necessary for the plurality of resource supplying facilities to supply the resources of the total demand based on the total demand and a cost necessary for the plurality of resource supplying facilities to supply the resources; and
calculating optimum supply quantities of the respective resource supplying facilities based on the minimum cost, calculated by the minimum cost calculating unit, the total demand, and a supply quantity of the resources to be supplied from at least one resource supplying facility of the plurality of resource supplying facilities.
